(19) United States
(12) Patent Application Publication
(10) Pub. No.: US 2016/0369558 A1
(43) Pub. Date: Dec. 22, 2016

(54) VARIABLE RESISTANCE BRAKE FOR USE WITH A ROLLER TUBE OF A WINDOW TREATMENT

(71) Applicant: LUTRON ELECTRONICS CO., INC., Coopersburg, PA (US)

(72) Inventor: David A. Kirby, Zionsville, PA (US)

(73) Assignee: LUTRON ELECTRONICS CO., INC., Coopersburg, PA (US)

(21) Appl. No.: 14/744,445

(22) Filed: Jun. 19, 2015

(51) Int. Cl. E06B 9/80; E06B 9/68

(52) U.S. Cl. CPC E06B 9/80; E06B 9/68

(57) ABSTRACT

A variable resistance brake may be operably coupled to a window treatment, such as to the roller tube of a motorized roller shade. The variable resistance brake may generate a first braking force that resists rotation of the roller tube in a first rotational direction, and a second braking force that resists rotation of the roller tube in a second rotational direction. The first and second braking forces may have different magnitudes. The variable resistance brake may include an idler, a mandrel that is operably coupled to the idler, a spring that rides on the mandrel, and a bearing that is configured to operably engage with the roller tube and that is rotatable about the idler. The idler may be configured to be supported in a fixed position relative to the roller tube. The spring may define a first end that is fixed in position relative to the bearing.

### BACKGROUND

A window treatment may be mounted in front of one or more windows, for example to prevent sunlight from entering a space and/or to provide privacy. Window treatments may include, for example, roller shades, roman shades, venetian blinds, or draperies. A roller shade typically includes a flexible covering material, such as a shade fabric, that is wound onto an elongated roller tube. Such a roller shade may include a weighted hembar located at a lower end of the shade fabric. The hembar may cause the shade fabric to hang in front of one or more windows that the roller shade is mounted in front of.

Window treatments may be motorized, which may alleviate the need to manually adjust the positions of the covering materials of the window treatments. For example, a window treatment installation may include a plurality of motorized window treatments that may all be operated in unison via a single control, such as an RF remote control device. Typically, the motorized window treatments of such an installation are powered by a hardwired power source, such as an alternating-current power source, or are battery-powered.

A motorized window treatment may include features that enable tracking the movement of the covering material. For example, a motorized roller shade may be configured to monitor for motion of the roller tube. Such motion may occur, for example, when the covering material is manually moved, for example by a person pulling the covering material.

However, actively monitoring for movement of the covering material may correspond to an inefficient use of energy. For example, in a battery-powered roller shade, actively monitoring for roller tube movement may detrimentally impact battery life.

In order to preserve battery life, known battery-powered window treatments may have motion tracking features that are configured to “sleep” when the window treatments are not actively operated. In such configurations, motion tracking features may be configured to “wake up” in response to movement of roller tube.

However, such configurations often exhibit an inherent delay between the time when movement of the roller tube is initiated and the time when the motion tracking features wake up to begin tracking movement, such that at least a small portion of the roller tube movement may go undetected by the window treatment. These undetected movements may negatively impact the performance of such a window treatment, for example by hampering the ability of the window treatment to accurately maintain limit stops associated with the covering material.

### SUMMARY

As described herein, a variable resistance brake may be configured for use with a window treatment, such as a battery-powered motorized roller shade that includes a covering material that is attached to a roller tube. The variable resistance brake may be operatively attached to the roller tube of the motorized roller shade, such that rotation of the roller tube is imparted to the variable resistance brake.

The variable resistance brake may be configured to generate a first braking force that resists rotation of the roller tube in a first rotational direction, and to generate a second braking force that resists rotation of the roller tube in an opposed, second rotational direction. The first rotational direction may correspond to movement of the covering material toward a lowered position, and the second rotational direction may correspond to movement of the covering material toward a raised position. The first braking force may have a different magnitude from the second braking force. For example, the first braking force may have a higher magnitude than the second braking force.

In an example configuration, the variable resistance brake may include an idler, a mandrel that is operably coupled to the idler, a spring that rides on the mandrel, and a bearing that is configured to operably engage with the roller tube. The bearing may be configured to at least partially receive the mandrel, the spring, and the idler such that the bearing is rotatable about the idler. The idler may be configured to be supported in a fixed position relative to the roller tube. For example, the idler may be configured to be attached to a housing of the motorized roller shade.

The spring may define a first end that is fixed in position relative to the bearing. The mandrel may define a contact surface that the spring rides on as the bearing rotates about the idler. When the bearing is rotated in the first rotational direction, the spring may apply a first friction force against the mandrel, and when the bearing is rotated in the second rotational direction, the spring may apply a second friction force against the mandrel that is lower in magnitude than the first friction force.

### BRIEF DESCRIPTION OF THE DRAWINGS

FIG. 1A is an exploded view depicting components of an example battery-powered roller shade for use in an opening, the battery-powered roller shade including an example variable resistance brake.

FIG. 1B is a perspective view of the example battery-powered roller shade depicted in FIG. 1A, with the shade in a raised position.

FIG. 1C is a perspective view of the example battery-powered roller shade depicted in FIG. 1A, with the shade in a lowered position.

FIG. 2 is an exploded view depicting components of an example variable resistance brake that may be operably coupled to the roller tube of a window treatment.

FIG. 3 is a front elevation view of an example spring that may be a component of the example variable resistance brake depicted in FIG. 2.

FIG. 4 is a front elevation view of an example bearing that may be a component of the example variable resistance brake depicted in FIG. 2.

FIG. 5A is a perspective view of an example mandrel that may be a component of the example variable resistance brake depicted in FIG. 2.

FIG. 5B is a rear elevation view of the example mandrel depicted in FIG. 5A.

FIG. 6A is a perspective view of an example idler that may be a component of the example variable resistance brake depicted in FIG. 2.

FIG. 6B is a rear elevation view of the example idler depicted in FIG. 6A.

FIG. 7 is a section view of the example variable resistance brake depicted in FIG. 2.

FIG. 8A is a perspective view of another example bearing that may be a component of a variable resistance brake, such as the example variable resistance brake depicted in FIG. 2.

FIG. 8B is a front elevation view of the example bearing depicted in FIG. 8A.

FIG. 9A is a perspective view of another example bearing that may be a component of a variable resistance brake, such as the example variable resistance brake depicted in FIG. 2.

FIG. 9B is a rear elevation view of the example bearing depicted in FIG. 9A.

### DETAILED DESCRIPTION

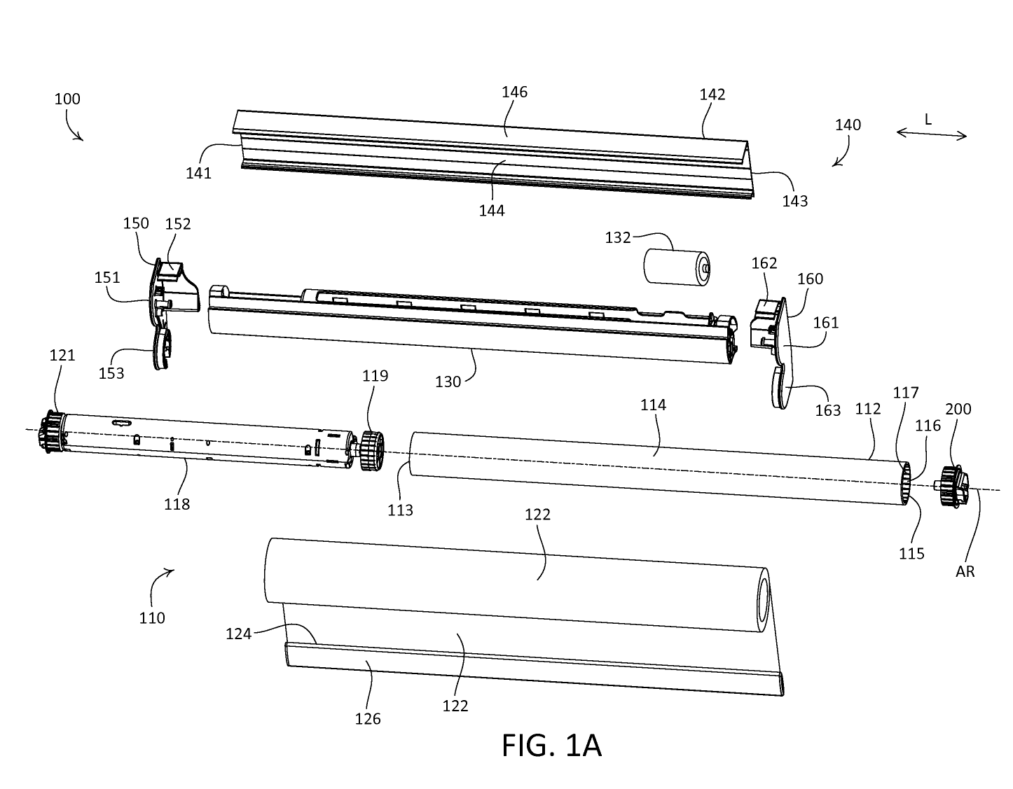

FIGS. 1A-1C depict an example motorized window treatment, in the form of a motorized roller shade 100, that may be mounted in front of an opening to prevent sunlight from entering a space and/or to provide privacy. The motorized roller shade 100 may be mounted to a structure that is proximate to the opening, such as a window frame, a wall, or other structure. As shown, the motorized roller shade 100 includes a shade assembly 110, a battery compartment 130, and a housing 140 that may be configured to support the shade assembly 110 and the battery compartment 130. The housing 140 may be configured as a mounting structure and/or a support structure for one or more components of the motorized roller shade 100.

As shown, the housing 140 includes a rail 142, a first housing bracket 150, and a second housing bracket 160. The illustrated rail 142 is elongate between a first end 141 and an opposed second end 143. The rail 142, the first housing bracket 150, and the second housing bracket 160 may be configured to attach to one another in an assembled configuration. For example, the first housing bracket 150 may be configured to be attached to the first end 141 of the rail 142, and the second housing bracket 160 may be configured to be attached to the second end 143 of the rail 142. As shown, the first housing bracket 150 defines an attachment member 152 that is configured to engage the first end 141 of the rail 142, and the second housing bracket 160 defines an attachment member 162 that is configured to engage the second end 143 of the rail 142. It should be appreciated that the rail 142, the first housing bracket 150, and the second housing bracket 160 are not limited to the illustrated attachment members.

One or more of the rail 142, the first housing bracket 150, or the second housing bracket 160, may be sized for mounting to a structure. For example, the rail 142 may be sized such that, with the first and second housing brackets 150, 160 attached to the rail 142, the rail 142 may be mounted to a structure in an opening (e.g., to a window frame). In such an example configuration, the rail 142 may define a length, for example as defined by the first and second ends 141, 143, such that the housing 140 may fit snugly in a window frame (e.g., with little clearance between the first and second housing brackets 150, 160 and adjacent structure of a window frame). This configuration may be referred to as an internal mount configuration. In another example, the rail 142 may be sized such that, with the first and second housing brackets 150, 160 attached to the rail 142, the rail 142 may be mounted to a structure above an opening (e.g., to a surface above a window). In such an example configuration, the rail 142 may define a length that is substantially equal to (e.g., slightly longer than) a width of the window opening. In still another example, one or more of the rail 142, the first housing bracket 150, or the second housing bracket 160 may be sized such that the motorized roller shade 100 may be mounted within a cavity defined by a window treatment pocket that may be mounted to a structure, such as structure surrounding a window. It should be appreciated, however, that the motorized roller shade 100 is not limited to these example mounting configurations.

The rail 142 may define any suitable shape. As shown, the rail 142 includes a rear wall 144 and an upper wall 146 that extends outward from an upper edge of the rear wall 144 along a direction that is substantially perpendicular to the rear wall 144. One or both of the rear wall 144 and the upper wall 146 may be configured to be mounted to a structure. The rail 142, the first housing bracket 150, and the second housing bracket 160, when in an assembled configuration, may define a cavity. The shade assembly 110 and the battery compartment 130 may be disposed in the cavity, for example when the motorized roller shade 100 is in an assembled configuration (e.g., as shown in FIGS. 1B and 1C). When the motorized roller shade 100 is in an assembled configuration, the housing 140 may be open at the front and bottom, such that the shade assembly 110 and the battery compartment 130 are exposed. The motorized roller shade 100 may optionally include a fascia (not shown) that is configured to conceal one or more components of the motorized roller shade 100, such as the battery compartment 130 and portions of the shade assembly 110.

As shown, the shade assembly 110 includes a roller tube 112, a motor drive unit 118, a covering material 122 (e.g., a shade fabric), a hembar 126, and a variable resistance brake 200. The roller tube 112 may have a tube body 114 that is elongate along a longitudinal direction L from a first end 113 to an opposed second end 115. The tube body 114 may define any shape, such as the illustrated cylindrical shape. As shown, the roller tube 112 is hollow, and open at the first and second ends 113, 115. The roller tube 112 may be configured to at least partially receive the motor drive unit 118, and to at least partially receive the variable resistance brake 200. As shown, the roller tube 112 is configured such that a portion of the motor drive unit 118 may be disposed in the first end 113, and such that a portion of the variable resistance brake 200 may be disposed in the second end 115.

The tube body 114 may define an inner surface 116 that is configured to operatively engage with the motor drive unit 118 and with the variable resistance brake 200. For example, as shown, the tube body 114 defines a plurality of splines 117 that extend radially inward from the inner surface 116. The roller tube 112 may be configured to operatively engage with the motor drive unit 118 and the variable resistance brake 200 via the plurality of splines 117. For example, the splines 117 may be configured to operatively engage with a component of the motor drive unit 118, such that rotational torque may be transferred to the roller tube 112 from the motor drive unit 118, thereby causing the roller tube 112 to rotate about an axis of rotation AR that extends parallel to the longitudinal direction L. The splines 117 may be configured to operatively engage with a component of the variable resistance brake 200, such that rotational torque transferred to the roller tube 112 from the motor drive unit 118 may be resisted by a force generated by the variable resistance brake 200. The force applied by the variable resistance brake 200 may vary, for example, based on a rotational direction of the roller tube 112. The axis of rotation AR of the roller tube 112 may also be referred to as a central axis of the roller tube 112.

As shown, the splines 117 extend parallel to the longitudinal direction L, and are spaced apart from each other equally along a circumference of the inner surface 116 of the roller tube 112, such that the circumferential distance is equal between any two circumferentially adjacent splines 117. Each of the illustrated splines 117 extends from the first end 113 to the second end 115 of the tube body 114. It should be appreciated that the roller tube 112 is not limited to the illustrated configuration and/or geometry of splines 117. It should further be appreciated that the roller tube 112 may be alternatively configured to operably engage with the motor drive unit 118 and/or the variable resistance brake 200. For example, in accordance with an alternative configuration of the roller tube 112, the tube body 114 may define a smooth inner surface 116, and may define one or more openings that extends through the tube body 114 at respective locations such that the roller tube 112 may be operatively coupled to the motor drive unit 118 and/or the variable resistance brake 200 via one or more fasteners that may be disposed into respective ones of the openings and that may engage the motor drive unit 118 and/or the variable resistance brake 200 (e.g., such as screws, pins, clips, or the like).

The illustrated motor drive unit 118 may be configured to be disposed into the first end 113 of the roller tube 112. One or more components of the motor drive unit 118 may be configured to engage with the plurality of splines 117 of the roller tube 112. As shown, the motor drive unit 118 includes a drive hub 119 that defines a plurality of grooves that are configured to operably engage with corresponding ones of the splines 117, such that operation of the motor drive unit 118 may cause the roller tube 112 to rotate. The motor drive unit 118 may further include an integrated idler 121 that defines a plurality of grooves that are configured to engage with corresponding ones of the splines 117.

The covering material 122 may define an upper end (not shown) that is configured to be operably attached to the roller tube 112, and an opposed lower end 124 that is configured as a free end. Rotation of the roller tube 112 about the axis of rotation AR, for example rotation caused by the motor drive unit 118, may cause the covering material 122 to wind onto, or to unwind from, the roller tube 112. In this regard, the motor drive unit 118 may adjust the covering material 122, for instance between raised and lowered positions of the covering material 122 as shown in FIGS. 1B and 1C, respectively.

Rotation of the roller tube 112 in a first rotational direction about the axis of rotation AR may cause the covering material 122 to unwind from the roller tube 112, for example as the covering material 122 is operated to a lowered position relative to an opening (e.g., a window). FIG. 1C depicts the motorized roller shade 100 with the covering material 122 in a lowered position. Rotation of the roller tube 112 in a second rotational direction, about the axis or rotation AR, that is opposite the first rotational direction may cause the covering material 122 to wind onto the roller tube 112, for example as the covering material 122 is operated to a raised position relative to the opening. FIG. 1B depicts the motorized roller shade 100, with the covering material 122 in a raised position.

The covering material 122 may be made of any suitable material, or combination of materials. For example, the covering material 122 may be made from one or more of “scrim,” woven cloth, non-woven material, light-control film, screen, or mesh. The hembar 126 may be attached to the lower end 124 of the covering material 122, and may be weighted, such that the hembar 126 causes the covering material 122 to hang (e.g., vertically) in front of an opening, such as one or more windows.

The motor drive unit 118 may be configured to enable control of the rotation of the roller tube 112, for example by a user of the motorized roller shade 100. For example, a user of the motorized roller shade 100 may control the motor drive unit 118 such that the covering material 122 is moved to a desired position. The motor drive unit 118 may include a sensor that monitors a position of the roller tube 112. This may enable the motor drive unit 118 to track a position of the covering material 122 relative to respective upper and lower limits of the covering material 122. The upper and lower limits may be specified, for example by an operator of the motorized roller shade 100, and may correspond to the raised and lowered positions of the covering material 122, respectively.

The motor drive unit 118 may be manually controlled (e.g., by actuating one or more buttons) and/or wirelessly controlled (e.g., using an infrared (IR) or radio frequency (RF) remote control unit). Examples of motor drive units for motorized roller shades are described in greater detail in U.S. Pat. No. 6,983,783, issued Jan. 10, 2006, entitled “Motorized Shade Control System,” U.S. Pat. No. 7,839,109, issued Nov. 23, 2010, entitled “Method Of Controlling A Motorized Window Treatment,” U.S. Pat. No. 8,950,461, issued Jan. 21, 2015, entitled “Motorized Window Treatment,” and U.S. Pat. No. 9,045,939, issued May 13, 2015, entitled “Battery-Powered Motorized Window Treatment Having A Service Position,” the entire contents of each of which are incorporated herein by reference. It should be appreciated, however, that any motor drive unit or drive system may be used to control the roller tube 112.

The motorized roller shade 100 may include an antenna (not shown) that is configured to receive wireless signals (e.g., RF signals from a remote control device). The antenna may be in electrical communication with the motor drive unit 118 (e.g., via a control circuit or PCB), such that one or more wireless signals received from a remote control unit may cause the motor drive unit 118 to move the covering material 122 (e.g., between the lowered and raised positions). The antenna may be integrated with (e.g., pass through, be enclosed within, and/or be mounted to) one or more of the shade assembly 110, the battery compartment 130, the housing 140, or respective components thereof.

The battery compartment 130 may be configured to retain one or more batteries 132. The illustrated battery 132 may be, for example, a D cell (e.g., IEC R20) battery. One or more components of the motorized roller shade 100, such as the motor drive unit 118, may be powered by the one or more batteries 132. However, it should be appreciated that the motorized roller shade 100 is not limited to the illustrated battery-powered configuration. For example, the motorized roller shade 100 may be alternatively configured such that one or more components thereof, such as the motor drive unit 118, may be powered by an alternating current (AC) source, a direct current (DC) source, or any combination of power sources.

The battery compartment 130 may be configured to be operable between an opened position and a closed position, such that one or more batteries 132 may be accessible when the battery compartment 130 is in the opened position. Examples of battery compartments for motorized roller shades are described in greater detail in U.S. Patent Application Publication No. 2014/0305602, published Oct. 16, 2014, entitled “Integrated Accessible Battery Compartment For Motorized Window Treatment,” the entire contents of which is incorporated herein by reference.

The housing 140 may be configured to support one or both of the shade assembly 110 and the battery compartment 130. For example, the first and second housing brackets 150, 160 may be configured to support the shade assembly 110 and/or the battery compartment 130. As shown, the first and second housing brackets 150, 160 are configured to support the shade assembly 110 and the battery compartment 130 such that the battery compartment 130 is located (e.g., is oriented) above the shade assembly 110 when the motorized roller shade 100 is mounted to a structure. It should be appreciated that the motorized roller shade 100 is not limited to the illustrated orientation of the shade assembly 110 and the battery compartment 130. For example, the housing 140 may be alternatively configured to otherwise support the shade assembly 110 and the battery compartment 130 relative to each other (e.g., such that the battery compartment 130 is located below the shade assembly 110).

As shown, the first housing bracket 150 defines an upper portion 151 and a lower portion 153, and the second housing bracket 160 defines an upper portion 161 and a lower portion 163. The upper portion 151 of the first housing bracket 150 may be configured to support a first end of the battery compartment 130, and the upper portion 161 of the second housing bracket 160 may be configured to support a second end of the battery compartment 130. The upper portions 151, 161 of the first and second housing brackets 150, 160, respectively, may be configured to operably support the battery compartment 130, such that the battery compartment 130 is operable, between respective opened and closed positions, to provide access to one or more batteries 132 when the motorized roller shade 100 is mounted to a structure.

The lower portion 153 of the first housing bracket 150 may be configured to support the idler 121, and thus the first end 113 of the tube body 114 of the roller tube 112. The lower portion 163 of the second housing bracket 160 may be configured to support the variable resistance brake 200, and thus the second end 115 of the tube body 114 of the roller tube 112. The lower portions 153, 163 of the first and second housing brackets 150, 160, respectively, may be configured to operably support the shade assembly 110, such that the covering material 122 may be moved (e.g., between the lowered and raised positions).

The housing 140 may be configured to be mounted to a structure using one or more fasteners (e.g., one or more screws). For example, one or more of the rail 142, the first housing bracket 150, or the second housing bracket 160 may define one or more respective apertures that are configured to receive fasteners.

The components of the housing 140 may be made of any suitable material or combination of materials. For example, the rail 142 may be made of metal and the first and second housing brackets 150, 160 may be made of plastic. Although the illustrated housing 140 includes separate components, it should be appreciated that the housing 140 may be otherwise constructed. For example, the rail 142, the first housing bracket 150, and the second housing bracket 160 may be monolithic. In another example, the rail may include first and second rail sections that may be configured to attach to one another. In such an example configuration, the first rail section may include an integrated first housing bracket and the second rail section may include an integrated second housing bracket. One or more components of the housing 140 (e.g., one or more of the rail 142, the first housing bracket 150, or the second housing bracket 160) may be wrapped in a material (e.g., fabric), for instance to enhance the aesthetics of the housing 140.

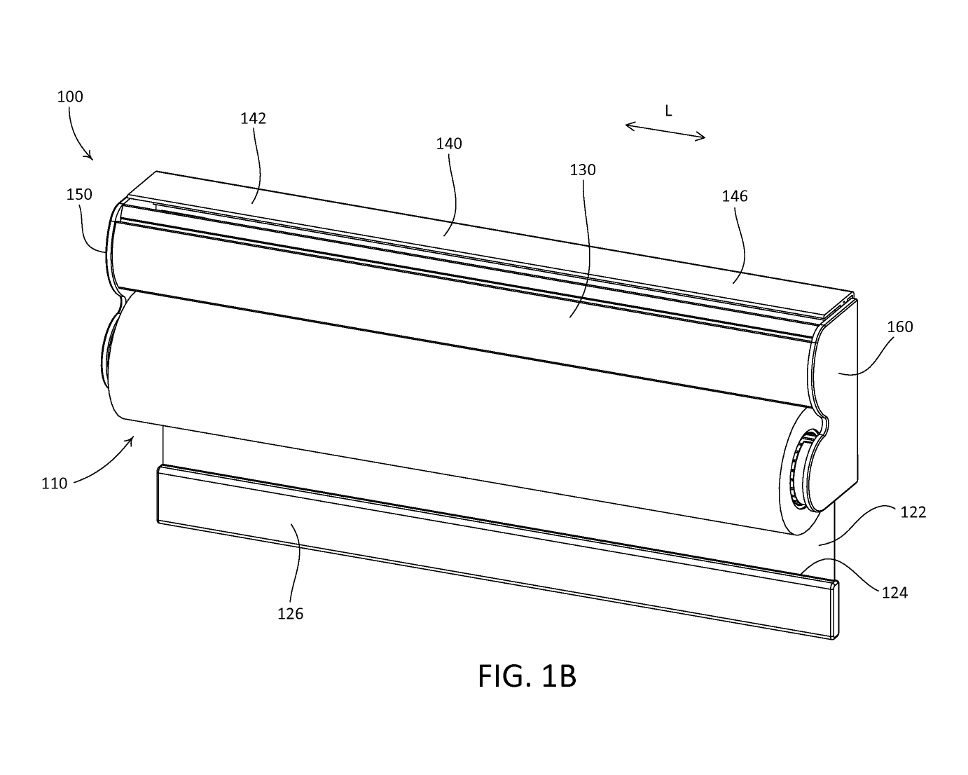

FIG. 2 is an exploded view depicting components of an example variable resistance brake 200 that may be operably coupled to the roller tube of a window treatment, such as the roller tube 112 of the motorized roller shade 100. As shown, the variable resistance brake 200 includes a retaining ring 202, a plate 204, a bearing 210, a spring 240, a mandrel 250, and an idler 270. The components of the variable resistance brake 200 may be concentrically aligned along the axis or rotation AR. The variable resistance brake 200 may alternatively be referred to as a variable resistance brake assembly.

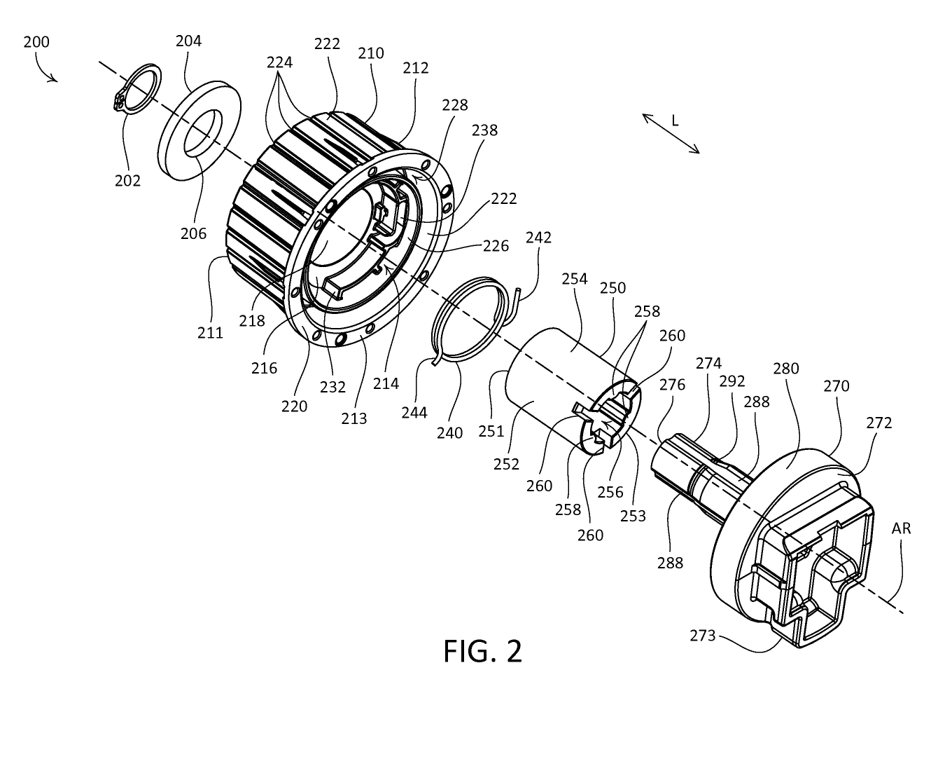

As shown in FIGS. 2 and 4, the bearing 210 includes a cylindrically shaped body 212 that defines a first end 211 and an opposed second end 213 that is spaced from the first end 211 along the longitudinal direction L. The first end 211 of the body 212 may be referred to as a rear end of the bearing 210, and the second end 213 of the body 212 may be referred to as a front end of the bearing 210. The bearing 210 may define a cavity 214 that extends into the second end 213 of the body 212. The cavity 214 may be configured to at least partially receive one or more other components of the variable resistance brake 200, such as the spring 240, the mandrel 250 and/or the idler 270. The body 212 may define any suitable shape for the cavity 214, such as the illustrated cylindrical shaped cavity 214. The bearing 210 may be made of any suitable material, such as plastic.

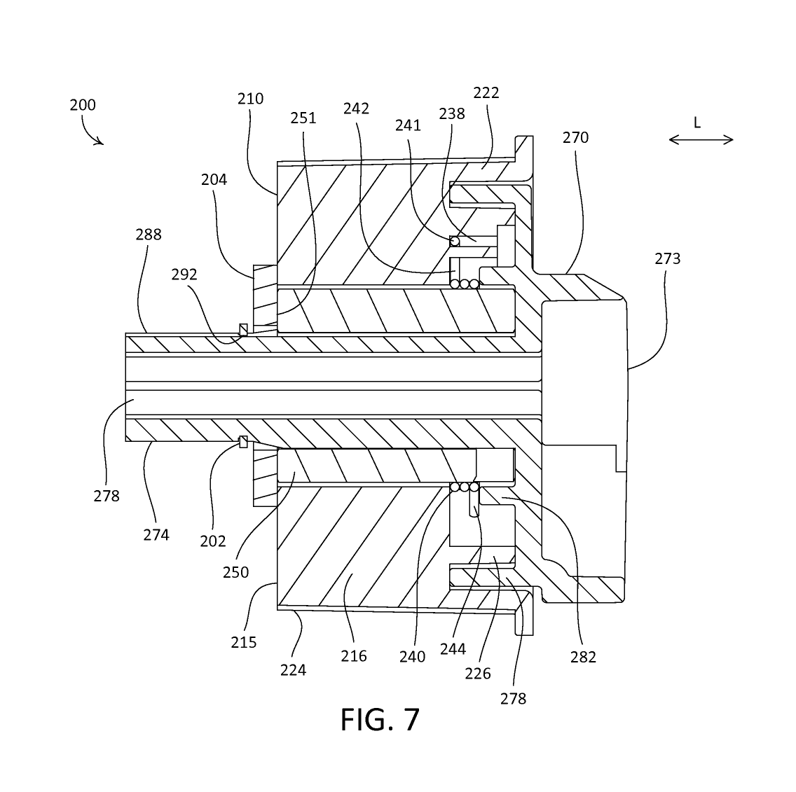

As shown, the cavity 214 extends inwardly into the body 212, and terminates at a rear wall 216 of the bearing 210. The rear wall 216 may define a bore 218 that is open to the cavity 214 and that extends through the rear wall 216 along the axis of rotation AR. The bore 218 may be configured to at least partially receive one or more other components of the variable resistance brake 200, such as the mandrel 250 and/or the idler 270. As shown, the bore 218 may define a diameter that is substantially equal to (e.g., slightly larger than) an outer diameter of the mandrel 250, such that the bearing 210 and a corresponding portion of the mandrel 250 may rotate relative to each other with little to no interference when the variable resistance brake 200 is in an assembled configuration (e.g., as shown in FIGS. 1A and 7). The body 212 of the bearing 210 defines a rim 220 that extends around the circumference at the second end 213. As shown, the rim 220 is configured to abut the second end 115 of the roller tube 112 when the bearing 210 is disposed into the roller tube 112.

The variable resistance brake 200 may be configured to be operably coupled to the roller tube 112 of the motorized roller shade 100 when disposed in the roller tube 112. For example, as shown, the body 212 of the bearing 210 may define a circumferential outer wall 222. The body 212 may define one or more grooves 224 that extend radially inward into the outer wall 222. The grooves 224 may be configured to operatively engage with corresponding ones of the splines 117 of the roller tube 112, such that rotational torque may be transferred from the roller tube 112 to the bearing 210, thereby causing the bearing 210 to rotate about the axis of rotation AR. It should be appreciated that the variable resistance brake 200 is not limited to the illustrated configuration wherein the variable resistance brake 200 is received in the second end 115 of the roller tube 112. For example, the motorized roller shade 100 may be alternatively configured such that the variable resistance brake 200 is at least partially received in, and operably coupled to, the first end 113 of the roller tube 112.

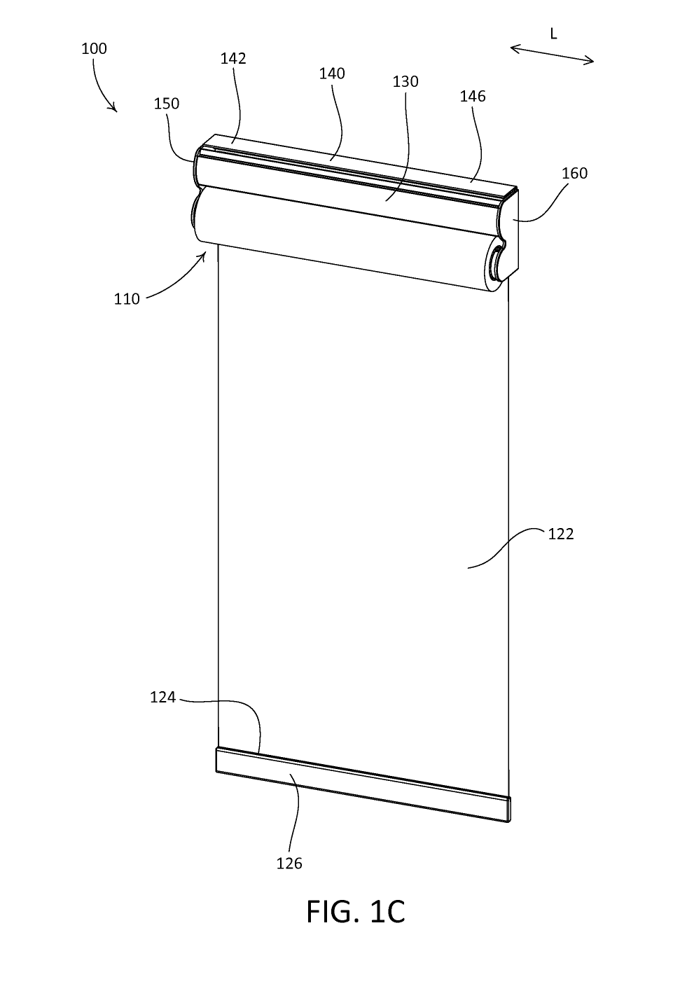

As shown in FIGS. 2 and 3, the spring 240 may be configured as a torsion spring that defines a first end 241, an opposed second end 243, and one or more coils between the first and second ends 241, 243. The coils may define an inner diameter of the spring 240 that is slightly smaller than an outer diameter of the mandrel 250. As shown, the spring 240 defines approximately three coils between the first and second ends 241, 243. The spring 240 may define tangs at one or both of the first and second ends 241, 243. For example, the illustrated spring 240 defines a first tang 242 at the first end 241, and defines a second tang 244 at the second tang 244 at the second end 243. As shown, the first tang 242 may be “U” shaped. The spring 240 may be made of any suitable material, such as metal.

Again referring to FIGS. 2 and 4, as shown, the body 212 of the bearing 210 may defines an annular inner rim 226 in the cavity 214 that is spaced from the outer wall 222, such that a channel 228 is defined between the inner rim 226 and the outer wall 222. The channel 228 may be configured to receive a corresponding portion of the idler 270. The body 212 may further define an arc shaped inner wall 230 that extends radially inward from the inner rim 226. The inner wall 230 may extend along a portion of a circumference of the inner wall 230, between a first end 232 and a second end 234. An open void 236 may be defined between the first and second ends 232, 234 of the inner wall 230.

The bearing 210 may be configured to engage with the spring 240 when the spring is disposed in place within the cavity 214. For example, the bearing 210 may be configured to captively retain the first tang 242 of the spring 240. As shown, the inner wall 230 defines a “J” shaped retention groove 238 that is open to the cavity 214 and that is configured to captively retain the first tang 242 of the spring 240. When the spring 240 is disposed in position in the cavity 214 of the bearing 210, the first tang 242 of the spring 240 may be captively received in the retention groove 238 and the second tang 244 of the spring 240 may be disposed in the void 236, for example at a location between the first and second ends 232, 234 of the inner wall 230. In this regard, the second end 243 of the spring 240 may be unrestrained relative to the bearing 210. When the first tang 242 of the spring 240 is disposed in the retention groove 238 and the variable resistance brake 200 is operatively coupled to the roller tube 112 of the motorized roller shade 100, the first tang 242 may be fixed in position relative to the roller tube 112 when the roller tube 112 is rotated in the first or second rotational directions. It should be appreciated that the first tang 242 of the spring 240 and the retention groove 238 are not limited to the illustrated geometries. It should further be appreciated that the first end 241 of the spring 240 may be alternatively secured in a fixed position relative to the bearing 210.

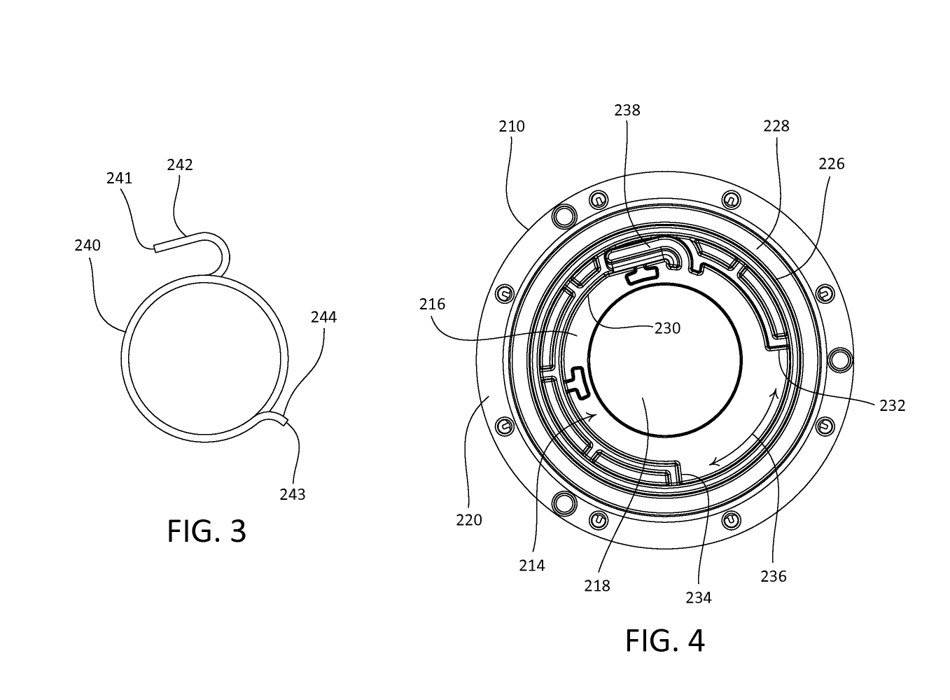

As shown in FIGS. 2 and 5A-5B, the mandrel 250 may have a body 252 that extends from a first end 251 to an opposed second end 253. The body 252 of the mandrel 250 may define any shape, such as the cylindrical shaped body that extends from the first end 251 to the second end 253. The mandrel 250 may be configured to carry the spring 240. In this regard, the spring 240 may ride on the mandrel 250. For example, the body 252 of the mandrel 250 may define an outer diameter that is slightly larger than the inner diameter of the spring 240, such that when the spring 240 is disposed onto the mandrel 250, the spring exerts a compressive force against the mandrel 250 when the spring 240 is at rest relative to the mandrel 250. The mandrel 250 may define a contact surface 254 that extends around a circumferential outer surface of the body 252. The spring 240 may abut the contact surface 254 when the spring 240 is disposed on the mandrel 250. In accordance with the illustrated configuration of the mandrel 250, the contact surface 254 is smooth. However, it should be appreciated that the contact surface 254 may be alternatively configured (e.g., textured) to enhance contact friction between the spring 240 and the mandrel 250. The body 252 of the mandrel 250 may define a bore 256 that extends therethrough along the axis of rotation AR. The bore 256 may be configured to receive a corresponding portion of the idler 270. The mandrel 250 may be made of any suitable material, such as metal.

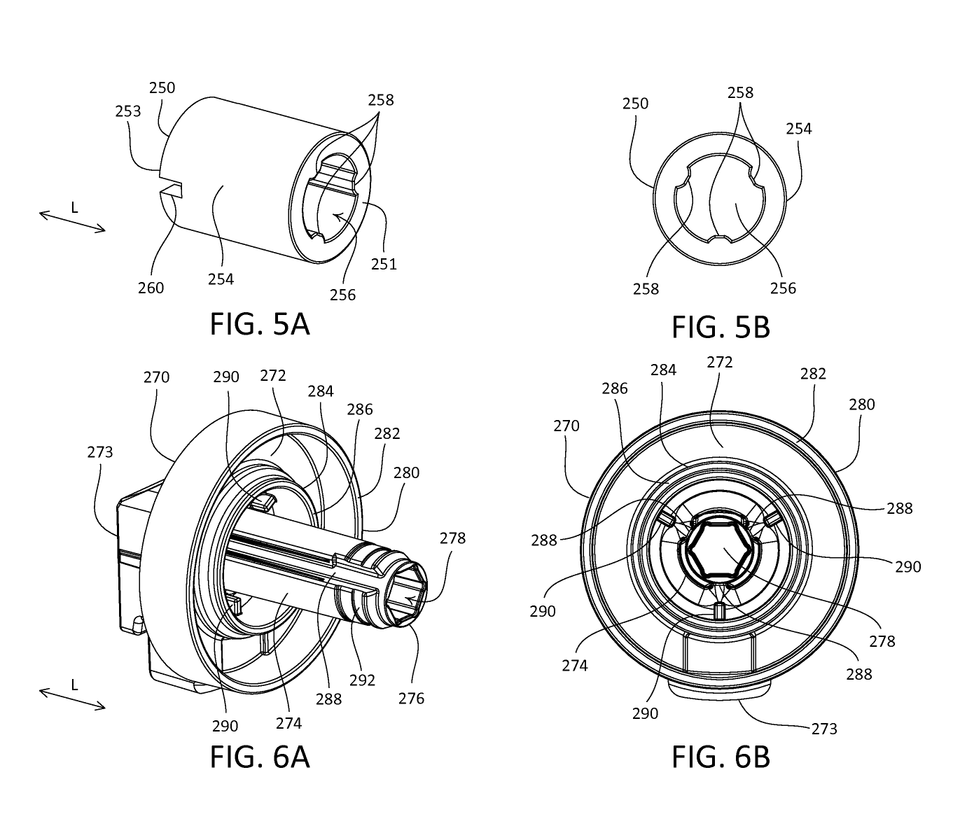

With further reference to FIGS. 6A-6B, the idler 270 may include a disc shaped base portion 272 and a shaft 274 that extends inwardly from the base portion 272 along the axis of rotation AR. The base portion 272 may define an attachment member 273 that extends outwardly from the base portion 272 and that is configured to releasably attach to the lower portion 163 of the second housing bracket 160 of the motorized roller shade 100. When attached to the housing 140 of the motorized roller shade 100, such as to the second housing bracket 160, the idler 270 may be supported in a fixed position relative to rotation of the roller tube 112. The idler 270 may be made of any suitable material, such as plastic.

The shaft 274 may be configured to be received in bore 256 of the mandrel 250. In this regard, the idler 270 may be configured to carry the mandrel 250, for example when the mandrel 250 is disposed onto the shaft 274. Further in this regard, the shaft 274 may be configured to carry the spring 240 (e.g., indirectly) when the spring 240 is disposed on the mandrel 250 and the mandrel 250 is disposed on the shaft 274. The shaft 274 may be at least partially received in the bearing 210 when the variable resistance brake 200 is in an assembled configuration. The shaft 274 may define a free end 276 that is spaced from the base portion 272 along the longitudinal direction L such that the free end 276 extends beyond the first end 251 of the mandrel 250 when the mandrel 250 is disposed onto the shaft 274, and furthermore extends beyond the first end 211 of the bearing 210 when the idler 270 is received in the cavity 214 in an assembled configuration of the variable resistance brake 200. The shaft 274 may define a bore 278 that extends therethrough along the longitudinal direction L. As shown, the bore 278 defines a hexagonal cross-sectional profile. However, it should be appreciated that the bore 278 may alternatively define any other suitable cross-sectional profile, such as circular.

The base portion 272 may define an annular outer rim 280 that extends inwardly from the base portion 272 along an outer circumference of the base portion 272, and that is centered along the axis of rotation AR. The outer rim 280 may be configured to be received in the channel 228 of the bearing 210, such that the outer rim 280 is rotatable within the channel 228. For example, the outer rim 280 may define an inner diameter that is slightly larger than an outer diameter of the inner rim 226 of the bearing 210, and an outer diameter that is slightly smaller than an inner diameter of the outer wall 222 of the bearing 210. The outer rim 280 may define an edge 282 that is spaced from the base portion 272 through a first distance along the longitudinal direction L that is shorter than a depth of the channel 228 (e.g., as defined by the rear wall 216 of the bearing 210). When the motorized roller shade 100 is in an assembled configuration (e.g., as shown in FIGS. 1B and 1C), the bearing 210 may be rotatable about the idler 270, for example when the motor drive unit 118 causes the roller tube 112 to rotate in the first or second rotational directions.

As shown, the base portion 272 may further define an annular inner rim 284 that extends inwardly from the base portion 272, that is centered along the axis of rotation AR, and that has a smaller diameter than that of the outer rim 280. The inner rim 284 may be configured to be received in a gap that is defined between the mandrel 250 and the inner wall 230 of the bearing 210 when the variable resistance brake 200 is in an assembled configuration. For example, the inner rim 284 may define an inner diameter that is slightly larger than the outer diameter of the mandrel 250, and an outer diameter that is slightly smaller than an inner diameter of the inner wall 230 of the bearing 210. The inner rim 284 may define an edge 286 that is spaced from the base portion 272 through a second distance along the longitudinal direction L that is shorter than the first distance that the edge 282 of the outer rim 280 is spaced from the base portion 272. The edge 286 may be spaced from the base portion 272 such that the edge 286 abuts the spring 240 when the variable resistance brake 200 is in an assembled configuration (e.g., as shown in FIG. 7). The edge 286 may bias the spring 240 into position against the rear wall 216 of the bearing 210 during assembly of the variable resistance brake 200.

The mandrel 250 and the idler 270 may be configured to be operably coupled to each other when the variable resistance brake 200 is in an assembled configuration. For example, as shown, the mandrel 250 may define one or more ribs 258 that extend radially inward into the bore 256, and the shaft 274 may define one or more grooves 288 that extend into an outer surface of the shaft 274 and that are configured to receive corresponding ones of the ribs 258. The ribs 258 may be referred to as first coupling members and the grooves 288 may be referred to as second coupling members. The illustrated ribs 258 extend along a length of the mandrel 250 (e.g., as defined from the first end 251 to the second end 253), and extend parallel to the longitudinal direction L. As shown, the mandrel 250 defines three ribs 258 that are spaced apart from each other equally along a circumference of the bore 256, such that the circumferential distance is equal between any two circumferentially adjacent ribs 258. The illustrated grooves 288 extend from the free end 276 of the shaft 274 toward the base portion 272, and extend parallel to the longitudinal direction L. As shown, the shaft 274 of the idler 270 defines three grooves 288 that are spaced apart from each other equally along a circumference of the shaft 274, such that the circumferential distance is equal between any two circumferentially adjacent grooves 288. When the mandrel 250 is disposed on the shaft 274, the ribs 258 may engage with corresponding ones of the grooves 288, such that the mandrel 250 is held in a fixed position about the axis of rotation AR relative to the idler 270 during operation of the variable resistance brake 200.

The mandrel 250 and the idler 270 may be further configured to be operably coupled to each other when the variable resistance brake 200 is in an assembled configuration. For example, as shown, the idler 270 may define one or more projections 290 that extend inwardly from the base portion 272 and radially outward from the shaft 274. The second end 253 of the mandrel may define one or more notches 260 that are configured to receive corresponding ones of the projections 290 when the mandrel 250 is disposed onto the shaft 274 in accordance with an assembled configuration of the variable resistance brake 200.

As shown, the shaft 274 of the idler 270 defines a circumferential groove 292 that extends radially inward into the outer surface of the shaft 274. The groove 292 may be configured to receive the retaining ring 202, for example when the variable resistance brake 200 is in an assembled configuration. The illustrated plate 204 defines an aperture 206 that extends therethrough along the longitudinal direction L. As shown, the aperture 206 may have a diameter that is slightly larger than an outer diameter of the shaft 274 and that is smaller than an outer diameter of the retaining ring 202. The plate may have an outer diameter that is larger than the diameter of the bore 218 of the bearing 210. The plate 204 may be disposed onto the shaft 274 of the idler 270 in an assembled configuration of the variable resistance brake 200, and may be retained on the shaft 274 by the retaining ring 202. The plate 204 may operate to retain the bearing 210 in position along the longitudinal direction L relative to the mandrel 250 and/or the idler 270.

In accordance with an example process of assembling the variable resistance brake 200, the mandrel 250 may be attached to the idler 270. For example, the ribs 258 of the mandrel 250 may be aligned with corresponding ones of the grooves 288 of the idler 270. The free end 276 of the shaft 274 of the idler 270 may be inserted into bore 256 of the mandrel, and the mandrel 250 may be slid into position along the shaft 274, for example such that the ribs 258 of the mandrel 250 are received in corresponding ones of the grooves 288 of the idler 270. The ribs 258 may engage within the grooves 288 to operably couple the mandrel 250 to the idler 270. As the mandrel 250 is slid onto the shaft 274, the projections 290 of the idler 270 may be received in corresponding ones of the notches 260 in the mandrel 250. The mandrel 250 may be removed from the shaft 274 by sliding the mandrel 250 away from the base portion 272 and off the shaft 274. In this regard, the mandrel 250 may be removably attached to the shaft 274 of the idler 270. It should be appreciated that one or both of the mandrel 250 and the idler 270 may be configured such that the mandrel 250 may be fixedly attached to the shaft 274 (e.g., using one or more fasteners).

With the mandrel 250 in position on the idler 270, the spring 240 may be disposed onto the mandrel 250, for example onto the contact surface 254. Optionally, a lubricating substance (e.g., grease) may be applied to the contact surface 254, for example before or after the spring 240 is disposed onto the mandrel 250. It should be appreciated that alternatively the spring 240 may be disposed onto the mandrel 250 before the mandrel is disposed onto the shaft 274 of the idler 270.

The sub-assembly comprising the spring 240, mandrel 250, and idler 270 may then be positioned within the bearing 210. For example, the shaft 274 of the idler 270 and the mandrel 250 may be disposed into the cavity 214 of the bearing 210, such that the outer rim 280 of the idler 270 is received in the channel 228 of the bearing 210, and such that the inner rim 284 of the idler 270 is received in the gap between the mandrel 250 and the inner wall 230 of the bearing 210. As it is disposed into the bearing 210, the sub-assembly of the spring 240, mandrel 250, and idler 270 may be positioned such that the first tang 242 of the spring 240 is aligned with and received in the retention groove 238, and the second tang 244 of the spring is received in the void 236. As the sub-assembly of the spring 240, mandrel 250, and idler 270 is disposed into position within the cavity 214 of the bearing 210, portions of the shaft 274 and the mandrel 250 may be received in the bore 218, and the edge 286 of the inner rim 284 may bias the spring 240 into position against the rear wall 216 of the bearing 210.

With the sub-assembly of the spring 240, mandrel 250, and idler 270 disposed in an assembled position relative to the bearing 210, the first end 251 of the mandrel 250 may be substantially aligned with a rear surface 215 of the bearing 210, and a portion of the shaft 274, including the free end 276, may protrude beyond the rear surface 215 (e.g., as shown in FIG. 7). The plate 204 may be disposed into position, for example by disposing the aperture 206 over the free end 276 of the shaft 274, and abutting the plate 204 against one or both of the rear surface 215 of the bearing and the first end 251 of the mandrel 250. With the plate 204 in position, the retaining ring 202 may be disposed into, and secured in position within, the groove 292 in the shaft 274. The variable resistance brake 200 may now be in an assembled configuration (e.g., as shown in FIG. 7).

In operation, the variable resistance brake 200 may generate one or more forces that resist rotation of the roller tube 112. For instance, the variable resistance brake 200 may generate respective magnitudes of force (e.g., frictional forces applied to the contact surface 254 of the mandrel 250) based on a rotational direction of the roller tube 112.

In an example of operation, the variable resistance brake 200 apply a first force that resists rotation of the roller tube 112 in a first rotational direction that corresponds to the covering material 122 unwinding from the roller tube 112 (e.g., as the covering material 122 is moved toward the lowered position), and to apply a second force that resists rotation of the roller tube 112 in a second rotational direction that corresponds to the covering material 122 winding onto the roller tube 112 (e.g., as the covering material 122 is moved toward the raised position). The first and second forces may be referred to as first and second braking forces. The first and second forces may be, for example, first and second frictional forces generated by rotational contact of the spring 240 on contact surface 254 of the mandrel 250. The variable resistance brake 200 may be configured such that the first braking force exceeds the second braking force. Stated differently, the variable resistance brake 200 may be configured to apply greater resistance against lowering of the covering material 122 than against raising of the covering material 122.

In accordance with an example of operation of the variable resistance brake 200 when installed in the motorized roller shade 100, the motor drive unit 118 may cause the roller tube 112 to rotate in the first rotational direction to unwind the covering material 122 from the roller tube 112. As the roller tube 112 begins to rotate in the first rotational direction, the bearing 210 may rotate along with the roller tube 112. As the bearing 210 begins to rotate in the first rotational direction, the first tang 242 of the spring 240 may engage with the bearing 210 in the retention groove 238. The mandrel 250 and idler 270 will remain in a static position relative to the roller tube 112 as the roller tube 112 rotates. As the roller tube 112 continues to rotate in the first rotational direction, engagement of the first tang 242 in the retention groove 238 may cause the spring 240 to tighten about the contact surface 254 of the mandrel 250 before the spring 240 begins to rotate about the mandrel 250, thereby causing the spring 240 and the mandrel 250 to generate a first frictional force that resists rotation of the bearing 210, and thus the roller tube 112, in the first rotational direction.

Further in accordance with the example of operation of the variable resistance brake 200 with the motorized roller shade 100, the motor drive unit 118 may cause the roller tube 112 to rotate in the second rotational direction to wind the covering material 122 onto the roller tube 112. As the roller tube 112 begins to rotate in the second rotational direction, the bearing 210 may rotate along with the roller tube 112. As the bearing 210 begins to rotate in the second rotational direction, the first tang 242 of the spring 240 may engage with the bearing 210 in the retention groove 238. The mandrel 250 and idler 270 will remain in a static position relative to the roller tube 112 as the roller tube 112 rotates. As the roller tube 112 continues to rotate in the second rotational direction, engagement of the first tang 242 in the retention groove 238 may cause the spring 240 to rotate about the contact surface 254 of the mandrel 250, thereby causing the spring 240 and the mandrel 250 to generate a second frictional force that resists rotation of the bearing 210, and thus the roller tube 112, in the second rotational direction. Rotation of the bearing 210 in the second rotational direction may not cause the spring 240 to tighten about the mandrel 250, such that the second frictional force is of lesser magnitude than the first frictional force. Stated differently, the magnitude of the first frictional force may exceed the magnitude of the second frictional force.

The respective magnitudes of the first and second frictional forces may be dictated via configuration of one of more components of the variable resistance brake 200. For example, one or both of the spring 240 and the mandrel 250 may be configured such that the first braking force has a magnitude of about 1 inch-pound to about 2.5 inch pounds, such as about 1.5 inch-pounds to about 2 inch-pounds, and such that the second braking force has a magnitude of less than 0.5 inch pounds.

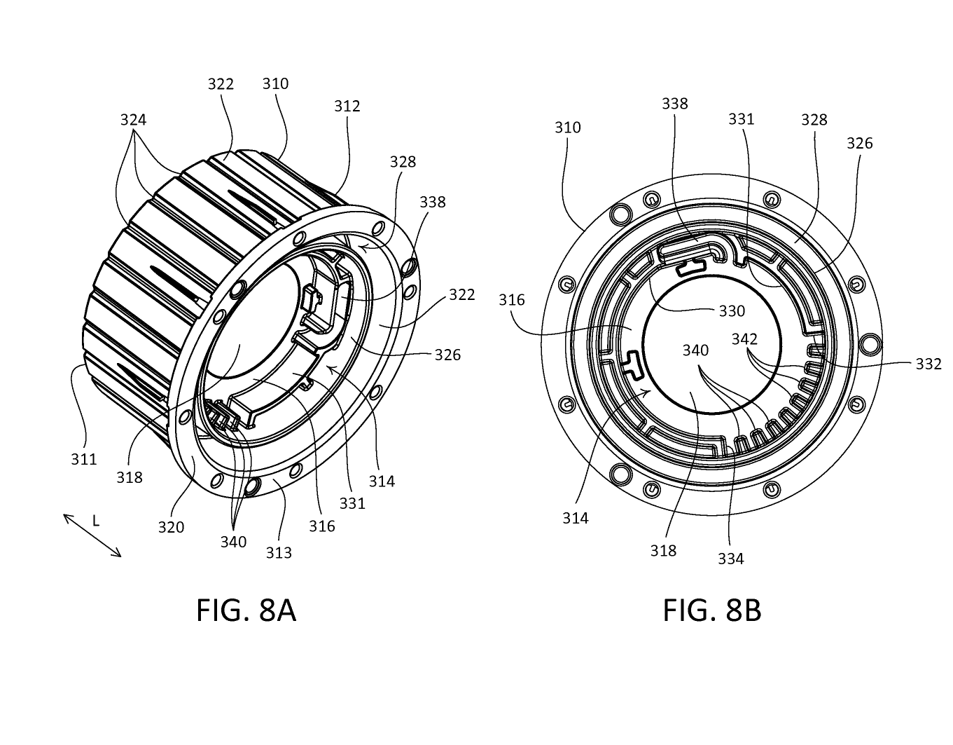

FIGS. 8A and 8B depict another example bearing 310 that may be a component of a variable resistance brake, such as the example variable resistance brake 200. For example, the bearing 310 may be installed in the variable resistance brake 200, in place of the bearing 210. The bearing 310 may be configured similarly to the bearing 210. For example, as shown, the bearing 310 includes a cylindrically shaped body 312 that defines a first end 311 and an opposed second end 313 that is spaced from the first end 311 along the longitudinal direction L. The first end 311 of the body 312 may be referred to as a rear end of the bearing 310, and the second end 313 of the body 312 may be referred to as a front end of the bearing 310. The bearing 310 may define a cavity 314 that extends into the second end 313 of the body 312. The cavity 314 may be configured to at least partially receive one or more other components of the variable resistance brake 200, such as the spring 240, the mandrel 250 and/or the idler 270. The body 312 may define any suitable shape for the cavity 314, such as the illustrated cylindrical shaped cavity 314. The bearing 310 may be made of any suitable material, such as plastic.

As shown, the cavity 314 extends inwardly into the body 312, and terminates at a rear wall 316 of the bearing 310. The rear wall 316 may define a bore 318 that is open to the cavity 314 and that extends through the rear wall 316 along the axis of rotation AR. The bore 318 may be configured to at least partially receive one or more other components of the variable resistance brake 200, such as the mandrel 250 and/or the idler 270. As shown, the bore 318 may define a diameter that is substantially equal to (e.g., slightly larger than) an outer diameter of the mandrel 250, such that the bearing 310 and a corresponding portion of the mandrel 250 may rotate relative to each other with little to no interference when the variable resistance brake 200 is in an assembled configuration. The body 312 of the bearing 310 defines a rim 320 that extends around the circumference at the second end 313. As shown, the rim 320 is configured to abut the second end 115 of the roller tube 112 when the bearing 310 is disposed into the roller tube 112.

As shown, the body 312 of the bearing 310 may define a circumferential outer wall 322. The body 312 may define one or more grooves 324 that extend radially inward into the outer wall 322. The grooves 324 may be configured to operatively engage with corresponding ones of the splines 117 of the roller tube 112, such that rotational torque may be transferred from the roller tube 112 to the bearing 310, thereby causing the bearing 310 to rotate about the axis of rotation AR. The body 312 of the illustrated bearing 310 defines an annular inner rim 326 in the cavity 314 that is spaced from the outer wall 322, such that a channel 328 is defined between the inner rim 326 and the outer wall 322. The channel 328 may be configured to receive a corresponding portion of the idler 270. The body 312 may further define an arc shaped inner wall 330 that extends radially inward from the inner rim 326. The inner wall 330 may extend along a portion of a circumference of the inner wall 330, between a first end 332 and a second end 334. As shown, the inner wall 330 defines a “J” shaped retention groove 338 that is open to the cavity 314 and that is configured to captively retain the first tang 242 of the spring 240, such that the bearing 310 may engage with the spring 240 when the spring is disposed in place within the cavity 314. In this regard, when the first tang 242 of the spring 240 is disposed in the retention groove 338 and the variable resistance brake 200 is operatively coupled to the roller tube 112 of the motorized roller shade 100, the first tang 242 may be fixed in position relative to the roller tube 112 when the roller tube 112 is rotated in the first or second rotational directions.

The bearing 310 may be configured to assist with alignment of the first tang 324 of the spring 240 with the groove 338. For example, the body 312 of the bearing 310 may define one or more ribs 340 that extend radially inward into the cavity 314 from the outer wall 322, and that extend from the rear wall 316 along the longitudinal direction L. The inner wall 330 may extend further into the cavity 314 than the ribs 340, relative to the outer wall 322. Stated differently, respective inner ends 342 of the ribs 340 may be spaced through a first radial distance from a center of the bearing 310 that lies on the axis of rotation AR, and an inner surface 331 of the inner wall 330 may be spaced through a second radial distance from the center of the bearing 310 that is shorter than the first radial distance.

As shown, the body 312 of the bearing 310 defines a plurality of ribs 340 that are spaced apart from each other between the first and second ends 332, 334 of the inner wall 330. The spring 240 may be configured such that, when the first tang 242 of the spring 240 is received in the groove 338, the second tang 244 may be disposed between the first and second ends 332, 334 of the inner wall 330, and may extend beyond the inner surface 331 of the inner wall 330, but may not extend far enough to make contact with the ribs 340. In this regard, the second tang 244 may be received at any position between the first and second ends 332, 334 of the inner wall 330, for instance as the variable resistance brake 200 is assembled.

The ribs 340 may operate to prevent the first tang 242 of the spring 240 from becoming disposed between the first and second ends 332, 334 of the inner wall 330, for instance during assembly of the variable resistance brake 200. To illustrate, in accordance with assembly of an example of the variable resistance brake 200 that includes the bearing 310 (e.g., in lieu of the bearing 210), a sub-assembly that includes the idler 270, the mandrel 250, and the spring 240 may be disposed into the cavity 314 of the bearing 310. As the sub-assembly is disposed into the cavity 314, if the first tang 242 of the spring 240 is aligned between the first and second ends 332, 334 of the inner wall 330, the ribs 340 may make contact with the first tang 242, thereby preventing the first tang 242 from becoming disposed between the first and second ends 332, 334. The sub-assembly may then be rotated (e.g., via the idler 270), which may cause the first tang 242 of the spring 240 to become aligned with the groove 338, such that the first tang 242 may then be disposed into the groove 338.

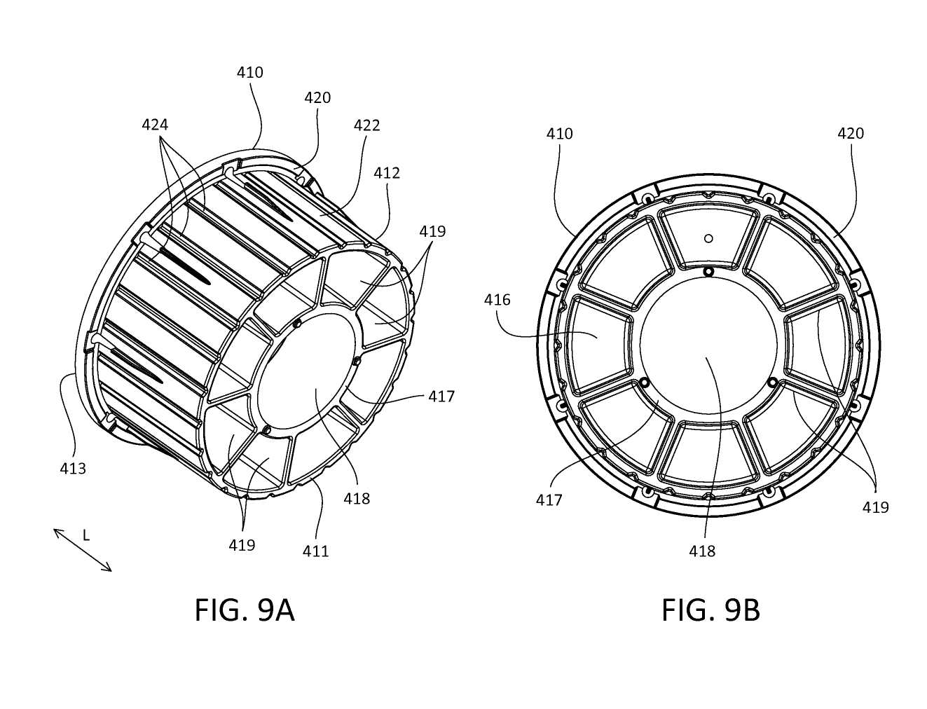

FIGS. 9A and 9B depict another example bearing 410 that may be a component of a variable resistance brake, such as the example variable resistance brake 200. For example, the bearing 410 may be installed in the variable resistance brake 200, in place of the bearing 210. As shown, the bearing 410 includes a cylindrically shaped body 412 that defines a first end 411 and an opposed second end 413 that is spaced from the first end 411 along the longitudinal direction L. The first end 411 of the body 412 may be referred to as a rear end of the bearing 410, and the second end 413 of the body 412 may be referred to as a front end of the bearing 410.

The bearing 410 may define a cavity (not shown) that extends into the second end 413 of the body 412. The cavity 414 may extend inwardly into the body 412, and terminate at a rear wall 416 of the bearing 410. The cavity 414 of the bearing 410 may be configured similarly to (e.g., may share one or more features with) the cavity 214 of the bearing 210 (e.g., defining the inner rim 226, the channel 228, the inner wall 230 including the void 236 and the retention groove 238, and so on), may be configured similarly to (e.g., may share one or more features with) the cavity 314 of the bearing 310 (e.g., defining the inner rim 326, the channel 328, the inner wall 330 including the retention groove 338, one or more ribs 340, and so on), or may be differently configured.

As shown, the body 412 of the bearing 410 may define a cylindrical sleeve 417 that extends rearward from the rear wall 416 to the first end 411 of the body 412, along the axis of rotation AR. The sleeve 417 may define a bore 418 that is open to the cavity. The bore 418 may be configured to at least partially receive one or more other components of the variable resistance brake 200, such as the mandrel 250 and/or the idler 270. As shown, the bore 418 may define a diameter that is substantially equal to (e.g., slightly larger than) an outer diameter of the mandrel 250, such that the bearing 410 and a corresponding portion of the mandrel 250 may rotate relative to each other with little to no interference when the variable resistance brake 200 is in an assembled configuration.

The body 412 of the bearing 410 defines a rim 420 that extends around the circumference at the second end 413. As shown, the rim 420 is configured to abut the second end 115 of the roller tube 112 when the bearing 410 is disposed into the roller tube 112. As shown, the body 412 of the bearing 410 may define a circumferential outer wall 422. The body 412 may define one or more grooves 424 that extend radially inward into the outer wall 422. The grooves 424 may be configured to operatively engage with corresponding ones of the splines 117 of the roller tube 112, such that rotational torque may be transferred from the roller tube 112 to the bearing 410, thereby causing the bearing 410 to rotate about the axis of rotation AR. The body 412 may further define one or more intermediate walls 419 that extend radially from the outer wall 422 to the sleeve 417. As shown, the body 412 of the bearing 410 defines seven intermediate walls 419 that are spaced apart from each other equally along a circumference of the outer wall 422, such that the circumferential distance is equal between any two circumferentially adjacent intermediate walls 419.

It should be appreciated that the variable resistance brake 200 is not limited to the illustrated configuration including the mandrel 250, and that the variable resistance brake 200 may be alternatively configured to differently define the contact surface upon which the spring 240 rides. For example, in an alternative configuration of the variable resistance brake 200, the mandrel 250 may be omitted and the shaft 274 of the idler 270 may be configured to define the contact surface that carries the spring 240. In this regard, the shaft 274 may be configured to carry the spring 240 (e.g., directly) when the spring 240 is disposed on the 274.

In accordance with such an alternative configuration of the idler 270, the shaft 274 of the idler 270 may define a cylindrical contact surface that is configured to carry the spring 240 and that is configured to be received in the cavity 214 of the bearing 210 and in bore 218. For example, the shaft 274 of the idler 270 may define a cylindrical portion having a diameter that is substantially equal to the outer diameter of the mandrel 250, and the contact surface may be defined on the cylindrical portion. In an example of operation of such an alternative configuration, the spring 240 may apply a first friction force against the contact surface of the shaft 274 when the bearing 210 is rotated in the first rotational direction, and may apply a second friction force against the contact surface of the shaft 274 when the bearing 210 is rotated in the second rotational direction. The second friction force may have a different magnitude from the first friction force. For example, the first friction force may exceed the second friction force.

It should further be appreciated that the variable resistance brake 200 is not limited to use with motorized window treatments, and that the variable resistance brake 200 may be integrated into other types of window treatments, such as manually operated roller shades. It should further still be appreciated that one or more components of the variable resistance brake 200 may be otherwise configured or omitted. For instance, the variable resistance brake 200 may be alternatively configured such that the plate 204 may be omitted. It should further still be appreciated that the motorized roller shade 100, including the variable resistance brake 200, may be installed to cover both regularly sized openings (e.g., standard size windows) and atypically large openings, such as a window, or cluster of windows, having a width greater than 8 feet, and up to about 15 feet wide, such as about 12 feet wide.

1. A motorized window treatment comprising:
a roller tube;
a motor drive unit that is at least partially received in the roller tube;
a covering material that is attached to the roller tube, the covering material operable between a raised position and a lowered position via rotation of the roller tube by the motor drive unit; and
a variable resistance brake that is operatively coupled to the roller tube, the variable resistance brake configured to apply a first braking force against rotation of the roller tube in a first rotational direction, and to apply a second braking force against rotation of the roller tube in a second rotational direction,
wherein the first braking force exceeds the second braking force.

2. The motorized window treatment of claim 1, wherein the variable resistance brake comprises:
a contact surface; and
a torsion spring that is configured to ride on the contact surface,
wherein the variable resistance brake is configured to cause the torsion spring to tighten about the contact surface when the roller tube is rotated in the first rotational direction, thereby generating the first braking force.

3. The motorized window treatment of claim 2, wherein the torsion spring defines a tang that is fixed in position relative to the roller tube when the roller tube is rotated in the first and second rotational directions.

4. The motorized window treatment of claim 3, wherein the variable resistance brake further comprises:
a bearing that is operably coupled to the roller tube, the bearing configured to captively retain the tang of the torsion spring; and
an idler about which the bearing is rotatable in the first and second rotational directions, the idler including a shaft that is at least partially received in the bearing, the shaft configured to carry the torsion spring.

5. The motorized window treatment of claim 4, wherein the variable resistance brake further comprises a mandrel that is configured to be operably coupled to the shaft and to be at least partially received in the bearing, wherein the mandrel defines the contact surface.

6. The motorized window treatment of claim 4, wherein the shaft of the idler defines the contact surface.

7. The motorized window treatment of claim 1, wherein the first rotational direction corresponds to the covering material unwinding from the roller tube and the second rotational direction corresponds to the covering material winding onto the roller tube.

8. The motorized window treatment of claim 1, wherein the first braking force has a magnitude of about 1 inch-pound to about 2.5 inch pounds.

9. The motorized window treatment of claim 1, wherein the first braking force has a magnitude of about 1.5 inch-pounds to about 2 inch-pounds.

10. The motorized window treatment of claim 1, wherein the second braking force has a magnitude of less than 0.5 inch pounds.

11. A variable resistance brake assembly comprising:
an idler;
a mandrel that is attached to the idler;
a bearing that is configured to operably engage with a roller tube of a window treatment, the bearing configured to at least partially receive the mandrel and the idler such that the bearing is rotatable about the idler;
a spring that rides on the mandrel, the spring having a first end that is fixed in position relative to the bearing and an opposed second end,
wherein when the bearing is rotated in a first rotational direction, the spring applies a first friction force against the mandrel, and
wherein when the bearing is rotated in an opposed, second rotational direction the spring applies a second friction force against the mandrel that is different in magnitude from the first friction force.

12. The variable resistance brake assembly of claim 11, wherein the bearing defines a cavity that is configured to at least partially receive the mandrel and the idler.

13. The variable resistance brake assembly of claim 12, wherein the idler defines a base portion and a shaft that extends from the base portion along an axis of rotation of the roller tube, the shaft configured to carry the mandrel and to be received in the cavity.

14. The variable resistance brake assembly of claim 13, wherein the mandrel defines a bore that is configured to receive the shaft, and
wherein the mandrel defines first coupling members and the shaft defines second coupling members, the first coupling members configured to engage with respective ones of the second coupling members to operably couple the mandrel to the idler.

15. The variable resistance brake assembly of claim 13, wherein the base portion of the idler defines an attachment member that is configured to releasably attach to a housing bracket of the window treatment.

16. The variable resistance brake assembly of claim 12, wherein the second end of the spring defines a tang that is disposed in the cavity.

17. The variable resistance brake assembly of claim 11, wherein the magnitude of the first friction force exceeds the magnitude of the second friction force.

18. The variable resistance brake assembly of claim 17, wherein the magnitude of the first friction force is about 1.5 inch-pounds to about 2 inch-pounds, and
wherein the magnitude of the second friction force is less than 0.5 inch pounds.

19. The variable resistance brake assembly of claim 11, wherein the spring is a torsion spring and wherein the mandrel defines a cylindrical contact surface on which the spring is disposed.

20. The variable resistance brake assembly of claim 11, wherein the second end of the spring is unrestrained relative to the bearing.

21. A variable resistance brake that is operatively attachable to a roller tube of a window treatment that includes a covering material that is attached to the roller tube, the variable resistance brake configured to:
when the roller tube is rotated in a first rotational direction that causes the covering material to unwind from the roller tube, generate a first force that resists rotation of the roller tube in the first rotational direction; and
when the roller tube is rotated in an opposed, second rotational direction that causes the covering material to wind onto the roller tube, generate a second force that resists rotation of the roller tube in the second rotational direction,
wherein the second force is different in magnitude from the first force.

22. A variable resistance brake assembly comprising:
an idler that defines a contact surface;
a bearing that is configured to operably engage with a roller tube of a window treatment, the bearing configured to at least partially receive the idler such that the bearing is rotatable about the idler;
a spring that rides on the contact surface of the idler, the spring having a first end that is fixed in position relative to the bearing, and an opposed second end,
wherein when the bearing is rotated in a first rotational direction, the spring applies a first friction force against the contact surface, and
wherein when the bearing is rotated in an opposed second rotational direction, the spring applies a second friction force against the contact surface that is different in magnitude from the first friction force.

23. The variable resistance brake assembly of claim 22, wherein the second end of the spring is unrestrained relative to the bearing.

24. The variable resistance brake assembly of claim 22, wherein the magnitude of the first friction force exceeds the magnitude of the second friction force.
